(19) United States
(12) Patent Application Publication
(10) Pub. No.: US 2012/0290883 A1
(43) Pub. Date: Nov. 15, 2012

(54) Computer Implemented Method for Precise May-Happen-in-Parallel Analysis with Applications to Dataflow Analysis of Concurrent Programs

(75) Inventor: Vineet Kahlon, Princeton, NJ (US)

(73) Assignee: NEC LABORATORIES AMERICA, INC., Princeton, NJ (US)

(21) Appl. No.: 13/294,746

(22) Filed: Nov. 11, 2011

Related U.S. Application Data
(60) Provisional application No. 61/412,646, filed on Nov. 11, 2010.
(60) Provisional application No. 61/502,517, filed on Jun. 29, 2011.

(51) Int. Cl. G06F 11/07

(52) U.S. Cl. 714/49; 714/E11.024

(57) ABSTRACT

A computer implemented method for automatically for determining errors in concurrent program using lock localization graphs for capturing few relevant lock/unlock statements and function calls required for reasoning about interference at a thread location at hand, responsive to first and second threads of a concurrent program, constructing generalized lock causality graphs and computing cycle signatures, and determining errors in the concurrent program responsive to computing an interference graph and data flow analysis.

This application claims the benefit of U.S. Provisional Application No. 61/502,517, entitled, “Efficient Reasoning about Thread Interference via Lock Localization Graphs”, filed Jun. 29, 2011; and claims the benefit of U.S. Provisional Application No. 61/412,646, entitled, “Precise May-Happen-in-Parallel Analysis with Applications to dataflow Analysis of Concurrent Programs”, filed Nov. 11, 2010, of which the contents of both are incorporated herein by reference.

### BACKGROUND OF THE INVENTION

The present invention relates generally to detecting errors in concurrent programs, and more specifically, a computer implemented method for precise may-happen-in-parallel analysis with applications to dataflow analysis of concurrent programs.

Dataflow analysis for concurrent programs is a problem of critical importance. Unfortunately, it is, in general, undecidable. The key obstacle is to determine for a control location 1 in a given thread, how other threads could affect dataflow facts at 1, i.e., capturing thread interference. Determining thread interference is closely connected with the may-happen-in-parallel (MHP) problem, i.e., whether two control locations in different threads are simultaneously reachable in the presence of scheduling constraints imposed by synchronization primitives. While the MHP problem has been well studied in the literature, there do not exist precise MHP analyses even for the most commonly used primitives, e.g., locks. Moreover, existing static MHP analyses handle scheduling constraints resulting from different synchronization primitives separately and fail to exploit the constraints resulting from the interactions between these primitives making these analyses imprecise.

Prior works in this problem area do not consider scheduling constraints arising from general locking patterns but only nested locks. Furthermore, constraints arising from wait/notify primitives are also not considered.

Accordingly, there is a need for a fully automatic, efficient and precise technique for lock insertion in concurrent code that ensures deadlock freedom while attempting to minimize the lengths of the resulting critical sections.

### BRIEF SUMMARY OF THE INVENTION

The present invention is directed to a computer implemented method for automatically for determining errors in concurrent program that includes i) using lock localization graphs for capturing few relevant lock/unlock statements and function calls required for reasoning about interference at a thread location at hand, responsive to first and second threads of a concurrent program; ii) constructing generalized lock causality graphs and computing cycle signatures, responsive to step i); and iii) determining errors in the concurrent program responsive to computing an interference graph and data flow analysis to output from step ii).

In an exemplary embodiment of the invention, the lock causality graphs include, responsive to a location c in the first thread and a location d in the second thread, computing seed edges to capture lock-induced causality constraints between locations of different threads imposed by locks held at the location c. If the locks held at end-points of existing edges induce further causality constraints, then the lock localization graphs step adds induced edges to capture lock-induced causality constraints resulting from locks held at end-points of existing edges.

These and other advantages of the invention will be apparent to those of ordinary skill in the art by reference to the following detailed description and the accompanying drawings.

### BRIEF DESCRIPTION OF THE DRAWINGS

FIG. 1 depicts in block diagram form an exemplary architecture for carrying out the inventive interference analysis for enabling determination of errors and fixes in a concurrent program;

FIG. 2 is a block diagram for the inventive interference analysis procedure depicted in FIG. 1;

FIG. 3 is a diagram detailing the lock localization graph steps (steps 1 and 2, blocks 204,205) of the inventive interference of FIG. 2, in accordance with the invention; and

FIG. 4 is a diagram detailing constructing a generalized lock causality graph and compute cycle signatures, step 3, block 207 in FIG. 2, in accordance with the invention.

### DETAILED DESCRIPTION

The present invention is directed to a computer-implemented method that provides for formulating a new notion of lock pattern automata that capture static reachability information for concurrent programs with both locks and wait/notify and/or broadcasts. Lock pattern automata (LPA) track local lock access patterns between consecutive pairs of control locations of interest, e.g., shared variable/wait-notify/broadcast accesses, in a thread. In order to isolate the locking statements to track we use the notion of a bi-directional lock causality graph (BLCG). LPAs are built once for each thread but may be queried time and again for deciding pairwise reachability between global control states of concurrent programs in order to determine thread interference. This compositional approach has many applications, including dataflow and static analysis of concurrent programs.

While, in general, reasoning about thread interference is an undecidable problem. The invention makes use of the fact that, in practice, in order to maximize parallelism the sizes of critical sections are kept as small and localized as possible. A key consequence is that for computing possible interference at a given thread location it often suffices to reason about localized regions of thread code surrounding that location. In order to exploit this observation we propose the new notion of a Lock Localization Graph (LLG) which is a recursive state machine that captures only the few relevant lock/unlock statements and function calls required for reasoning about interference at the thread location at hand. This has two main advantages. First there is a dramatic reduction in the size of problem as instead of reasoning about the whole program it suffices to reason only about a few local lock/unlock statements. Secondly, we need only take into account localized locking patterns instead of the locking patterns in the program at large. It turns out that in practice even though the locking patterns in the original programs may be convoluted due to lock/unlock statements occurring inside loops or interacting with recursion, it is often the case that LLGs are acyclic. While it is known that using Lock Causality Graphs (LCGs) we can reason efficiently about linear LLGs, i.e., straight-line code, we show that the problem becomes NP-complete for acyclic LLGs (and undecidable in general). However, by combining key insights from Lock Causality Graphs with the notion of Cycle Signatures, we propose an efficient poly-time heuristic for acyclic LLGs that is sound and complete, i.e, a decision procedure, for two threads. Leveraging LLGs then allows us to formulate a methodology for carrying out interference analysis in the presence of both lock and wait/notify primitives in a unified fashion.

Importantly, the inventive new and refined interference analysis enables providing a framework for precise dataflow analysis for concurrent C programs. As application we show how to reduce the bogus warning rate for static data race detection on a suite of Linux device drivers as well as application-level software.

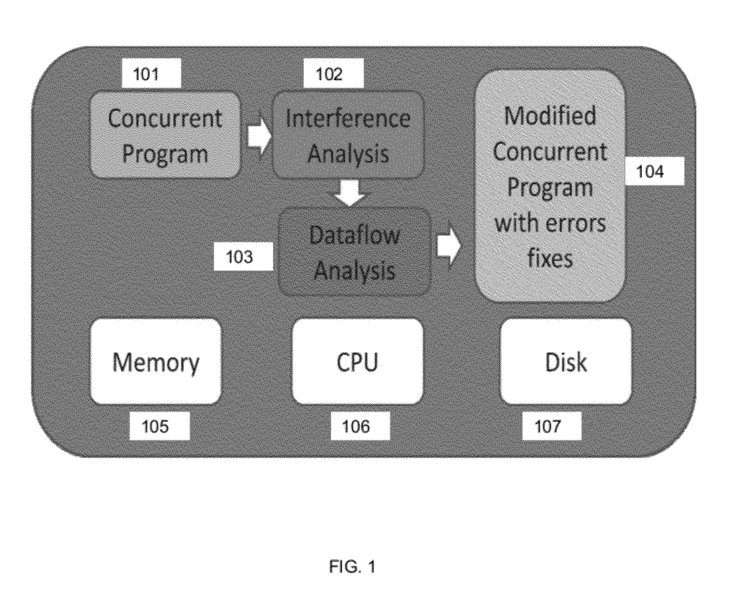

Referring to the architecture configuration of FIG. 1, including memory 105, CPU 106 and disc storage 107, a concurrent program 101 is analyzed by the inventive interference analysis 102 and dataflow analysis 103 to enable a modified said concurrent program 104 with errors identified and fixes.

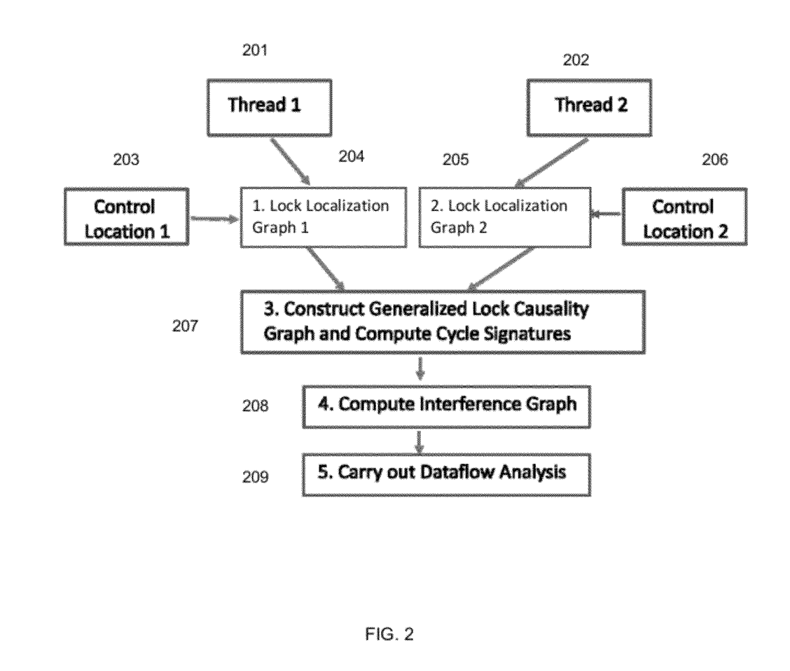

Referring now to the diagram of FIG. 2, detailing the interference step 102 of FIG. 1, lock localization graphs 1 and 2 are applied to respective threads 1 and 2 (201 and 202) of the concurrent program. The lock localization graphs 1 and 2 (204 and 205) are responsive to respective control locations 1 and 2 (203 and 206). Responsive to the lock localization graphs 204, 205, the inventive method constructs generalized lock causality graphs and computes cycle signatures 207. Then the inventive method computes an interference graph 208 and carries out a data flow analysis 209

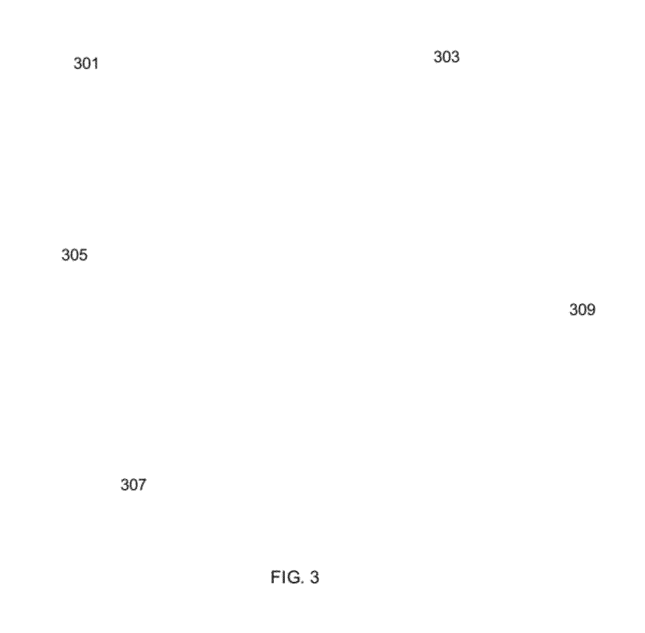

Referring now to the diagram of FIG. 3, shown are the details of the lock localization graph steps (steps land 2, blocks 204,205).

Responsive to locations c in thread 1 (301) and location d in thread 2 (303), the inventive method computes seed edges to capture lock-induced causality constraints between locations of different threads imposed by locks held at location c (305). If the locks held at end-points of existing edges induce further causality constraints 307, then the inventive method adds induced edges to capture lock-induced causality constraints resulting from locks held at end-points of existing edges 309. Otherwise, the inventive lock localization graphing steps quit and the inventive method proceeds to step 3, block 207 of FIG. 2.

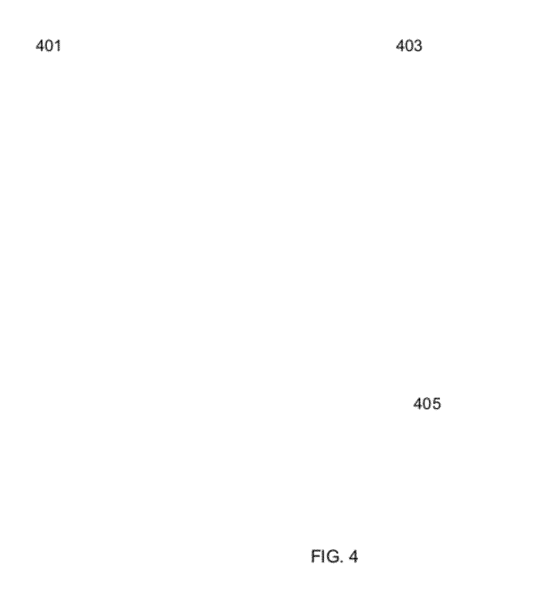

Referring now to the diagram of FIG. 4, shown are details of constructing a generalized lock causality graph and compute cycle signatures, step 3, block 207 in FIG. 2.

Responsive to the lock localization graph steps 204, 205, the inventive method traverses the lock localization graph of thread 1 to compute cycle signatures at each control location c in the graph that track end-points of cycles in the graph that are seen along all paths leading to c (block 401). The inventive method traverses the lock localization graph of thread 2 to compute cycle signatures at each control location d in the graph that track end-points of cycles in the graph that are seen along all paths leading to d (block 402). Responsive to the traversing steps 401, 403, the inventive method checks consistency of cycle signatures at c and d to determine whether there exist local paths in the lock localization graphs for threads 1 and 2 leading to c and d, respectively, which avoid all cycles—a necessary and sufficient condition for reachability of c and d.

From the foregoing, it can be appreciated that the inventive computer implemented method makes efficient dataflow analysis possible for a larger class of concurrent programs, i.e., programs with a broad class of non-nested locking pattern and improves precision of dataflow analysis by capturing thread interference in a sound and complete manner for the practically important case of acyclic LLGs.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method for automatically for determining errors in concurrent program comprising the steps of:
i) using lock localization graphs for capturing few relevant lock/unlock statements and function calls required for reasoning about interference at a thread location at hand, responsive to first and second threads of a concurrent program;
ii) constructing generalized lock causality graphs and computing cycle signatures, responsive to step i); and
iii) determining errors in said concurrent program responsive to computing an interference graph and data flow analysis to output from step ii).

2. The computer implemented method of claim 1, wherein said step i) of using lock causality graphs comprises, responsive to a location c in said first thread and a location d in said second thread, computing seed edges to capture lock-induced causality constraints between locations of different threads imposed by locks held at said location c.

3. The method of claim 2, wherein if said locks held at end-points of existing edges induce further causality constraints, then said step i) adds induced edges to capture lock-induced causality constraints resulting from locks held at end-points of existing edges, otherwise said step i) quits.

4. The method of claim 2, wherein said step ii) comprises traversing said lock localization graph of said first thread to compute cycle signatures at each control location c in said respective lock localization graph that track end-points of cycles in the graph that are seen along all paths leading to location c and traversing said lock localization graph of second thread to compute cycle signatures at each control location d in said respective lock localization graph that track end-points of cycles in the graph that are seen along all paths leading to location.

5. The method of claim 4, wherein said step ii) comprises, responsive to said traversing checking consistency of cycle signatures at locations c and d to determine whether there exist local paths in said lock localization graphs for said first and second threads leading to locations c and d, respectively, which avoid all cycles, a necessary and sufficient condition for reachability of c and d.
